(19) United States
(12) Patent Application Publication
(10) Pub. No.: US 2006/0043238 A1
(43) Pub. Date: Mar. 2, 2006

(54) Modular design with built-in upgradeability for aerospace applications

(76) Inventors: Haroon Inam, Rockford, IL (US); Jun Hu, Roscoe, IL (US); Byron R. Mehl, Belvidere, IL (US); Jeffrey T. Wavering, Rockford, IL (US)

Correspondence Address: Hamilton Sundstrand Corporation;Intellectual Property Dept/SGM, 4747 Harrison Avenue, P.O. Box 7002, Rockford, IL, 61125-7002, US

(21) Appl. No.: 10/930,626

(22) Filed: Aug. 31, 2004

(51) Int. Cl. B64C 1/00

(52) U.S. Cl. 244/129.1

(57) ABSTRACT

An improved line replaceable unit (LRU) of modular design for aerospace applications that has a plurality of removable LRU modules to enhance manufacturability, serviceability, interchangeability and upgradeability of the LRU.

### FIELD OF THE INVENTION

The invention relates to aerospace systems, and more particularly to aerospace systems with on-wing replaceable components.

### BACKGROUND OF THE INVENTION

Currently aerospace line-replaceable units (LRUs), modular aeronautical components that may be replaced on-aircraft, are designed as entire units that are each dedicated and released for a particular application and configuration. Whilst this is a generally preferred approach to LRU design, several pertinent characteristics and problems are noted with this prevalent approach.

The growing trend of using Commercial-off-the-Shelf (COTS) parts, particularly small electronic components, such as power dies, resistors, capacitors, microprocessors, and digital signal processors, field-programmable gate-arrays, application-specific integrated circuits and programmable logic devices to name a few, tends to offer a lower overall recurring cost of the LRU. However, the shorter life cycle of these components when compared to the greater than twenty year life-cycle of a typical aerospace LRU may cause extensive retest and certification costs when dealing with issues of component obsolescence.

Since the life-cycle operational costs of these LRUs include the cost of retest and recertification, the product-maintenance cost of life-cycle operations costs can be quite substantial. For instance, recertification alone can be in excess of US$1,000,000 per change for aerospace applications.

The growing improvements in the various parts provided by the commercial electronics industry also tend to have lower recurring costs in sequential and frequent updates, typically every 2 to 3 years, in addition to potentially enhanced performance characteristics. However, the high costs of retest and recertification of an entire LRU or an entire system prohibit the economic viability of making use of these lower recurring costs and improvements.

The relatively low volume of systems and LRUs for aerospace applications, typically in the range of 20 to 200 sets per year, result in a low-volume assembly line approach wherein yields, training and set-up are all affected negatively.

New LRU requirements for new aerospace applications may have a relatively high amount of functional commonality; however, since the configuration control is accomplished at the LRU level an entirely new design may have to be started from scratch. The issues related to parts obsolescence described above and the inability of previously designed closely matching LRUs to match the new requirements causes a substantially high non-recurring expense related to a new design. Typical new LRUs, such as those used in power electronics applications may cost millions of dollars per year to develop.

Feature enhancements related to functionality improvements are difficult to offer in an incremental fashion for the reasons described above. In addition, new and revolutionary features are difficult to incorporate within an LRU due to the rigidity of maintaining an LRU at the present configuration level, especially in aerospace applications. Maintenance and upgrade replacement at the aircraft level has to be accomplished at the level of LRUs. Since the recurring costs of the LRUs can be quite high, the costs of maintenance and inventory stocking are high as a result.

The total weight of such LRUs is the sum of all the components and materials within the chassis of the LRU plus the weight of an interconnection hardware. Heavier LRUs, such as those in the range of 30 or more pounds in weight, may require a two-person lift in order to service the LRU, even when only a small component within the said LRU is defective.

### SUMMARY OF THE INVENTION

The invention comprises a standard modular component for aeronautical applications, commonly referred to as a line-replaceable unit (LRU), that comprises a plurality of standardised, interchangeable and upgradeable LRU modules with levels of intra-platform and inter-platform commonality. By “modularising” the LRUs, many sub-modules may be shared across different LRUs to lower cost, improve serviceability and enhance upgradeability.

In a preferred embodiment, the invention comprises an improved line replaceable unit (LRU) with a modular structure for an application in an aerospace system that has a defined system requirement for the LRU, comprising: a plurality of LRU modules, with each LRU module serving at least one sub-requirement for the LRU; and an interface for coupling the LRU modules to each other and to the aerospace system.

### DESCRIPTION OF THE DRAWINGS

FIG. 1 shows a block diagram of a preferred embodiment of an exemplary power electronics LRU that is modularised according to the invention.

FIG. 2 shows examples of various system sub-requirements for exemplary LRUs that are conveniently modularised according to the invention.

FIG. 3 shows examples of virtual LRU modules that may comprise part of the LRU according to the invention.

FIG. 4 shows an example of a LRU module for a typical LRU according to the invention in the form of a power electronics switching block.

FIG. 5 shows an exploded perspective view of an entire modular LRU 2 according to the invention.

### DETAILED DESCRIPTION OF THE INVENTION

The invention overcomes the limited interchangeability and upgradeability of prior art LRU designs in aerospace applications with new designs that are based entirely on a multiple modular structure. Since the LRUs are themselves functional modules of an aerospace platform, an LRU design according to the invention may be characterised as a modularised module, or a module with a multiple modular structure. According to the invention, a module in the LRU modular structure may comprise both physical LRU modules and “virtual” LRU modules, that is, LRU modules without distinct physical boundaries, such as software. Further, each module within the LRU modular structure may be further broken down into its own modular structure of sub-modules, depending upon the unique application and the respective requirements related to the operational infrastructure of the aerospace application.

In such a LRU modular design according to the invention, the total system requirement for each LRU is broken down into a set of sub-system requirements. The criterion for breaking down the system requirements into sub-system requirements may be to enhance interchangeability, serviceability, usability or upgradeability. Sub-system requirements may define module functionality, form, fit, size, weight, recurring cost, nonrecurring cost, mean-time-between-failures (MTBF), mean-time-to-repair (MTTR) or any combination of such sub-system requirements. In addition, to implement the modularity concept the sub-requirements, interface characteristics, and performance of each LRU module must be clearly defined and then verified by analysis, qualification test. or both. The results must then be well documented and made usable for future design upgrade activity or use in other applications.

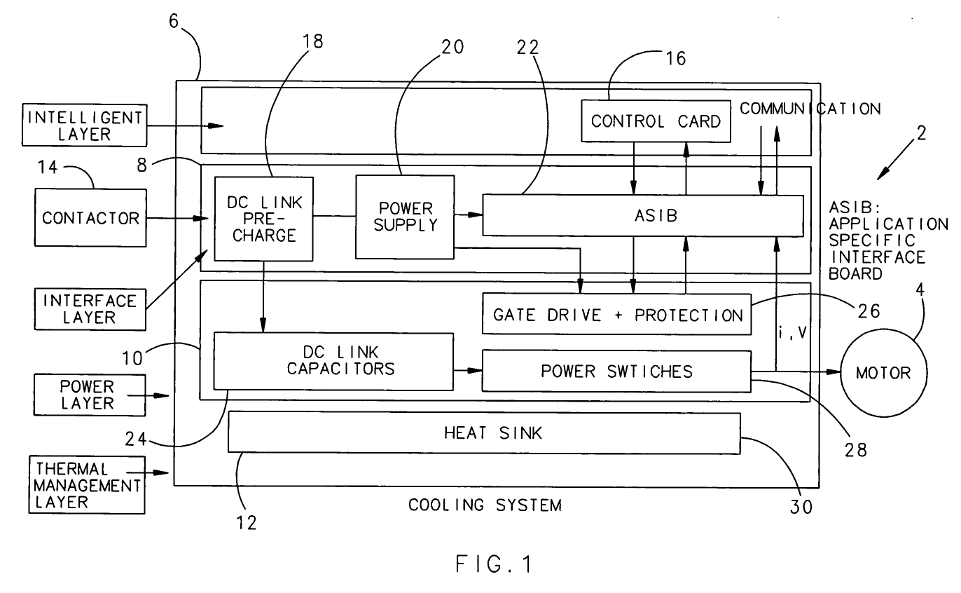

FIG. 1 shows a block diagram of a preferred embodiment of an exemplary power electronics LRU 2 that is sub-modularised according to the invention. In this LRU 2, which serves as a motor controller for a motor 4 that is part of an aerospace electrical power system (not shown), the LRU 2 is first broken down into sub-system requirements based on functionality. These comprise an intelligent layer 6, an interface layer 8, a power layer 10 and a thermal management layer 12. The intelligent layer 2 comprises communication between the power system and the LRU 2, such as control and feedback signals. The interface layer 8 responds to a signal from a contactor 14 and converts information processed by the intelligent layer 6 to power and drive signals that control the power layer 8. The power layer 8 produces motor control signals that operate the motor 4.

The layers 6, 8, 10, 12 are then further broken down into LRU modules based on sub-system requirements. In this case, the intelligent layer 6 is broken down into a LRU module that is based upon functionality. The intelligent layer 6 comprises a control card 16 that may have intra-platform, and even inter-platform, interchangeability with other LRUs. Likewise, the interface layer 8 comprises a direct current (DC) link pre-charge module 18, a power supply module 20 and an application specific interface board (ASIB) module 22. These LRU modules may also have interchangeability with other LRUs.

The power layer 10 is similarly broken down into LRU modules based upon reliability. In this case, the power layer 10 comprises a DC link capacitor module 24, a gate drive and protection circuitry module 26 and a power switches module 28. Basing these sub-modular components on reliability of operation allows more rapid and economical servicing of the LRU 2, since defective modules 18,20, 22 may be changed out without replacing the entire LRU. Similarly, the thermal management layer 12 is broken down into a LRU module that is based upon form and fit. In this case, it comprises a heat sink 30 that may have interchangeability with other LRUs.

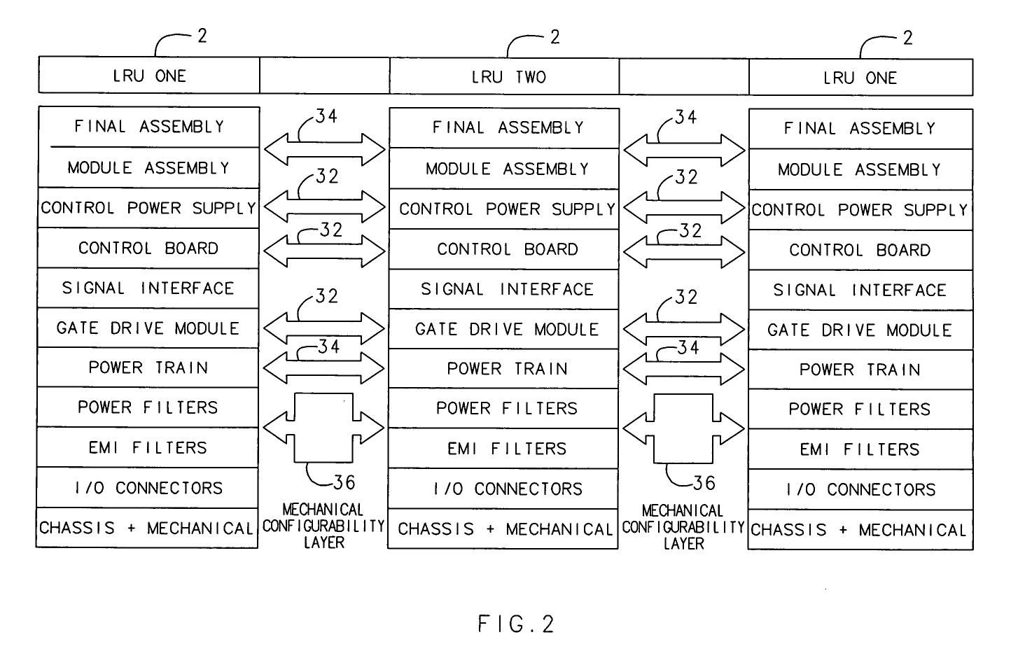

LRUs may be additionally or alternately modularised according to system requirements. For instance, the power supply module 20 may itself be sub-modularised to have a power filter module sub-module (not shown) that may have interchangeability with other LRUs. Similarly, each LRU 2 may be broken down into LRU modules based on other system sub-requirements. FIG. 2 shows examples of various system sub-requirements for exemplary LRUs that are conveniently modularised. These may also have some degree of intra-platform, and even inter-platform, interchangeability.

The LRU 2 may have a number of different modular designs, depending upon its application as one of a plurality of components of an aerospace system, such as an electrical power system. Both LRU modules and LRU virtual modules may be shared by more than one LRU modular design, so that different LRUs 2 may share at least some LRU modules and LRU virtual modules of the same type. Both LRU modules and LRU virtual modules may be replaced for conveniently servicing the LRU 2 without replacing the entire LRU 2. Furthermore, any LRU module or LRU virtual module may be replaced with an upgraded LRU module or LRU virtual module to upgrade the entire LRU 2.

In FIG. 2, system sub-requirements for each of three LRUs 2 for different power electronics applications in an aerospace electrical power system are shown. The degree of intra-platform, and even inter-platform, interchangeability are indicated by bi-directional arrows 32, 34 36. The bidirectional arrows 32 suggest that LRU modules designed for the respective system sub-requirements may have a high degree of interchangeability between LRUs 2. The bidirectional arrows 34 suggest that LRU modules designed for the respective system sub-requirements may have a medium degree of interchangeability between LRUs 2. The bidirectional arrows 36 suggest that LRU modules designed for the respective system sub-requirements are likely to have a low degree of interchangeability between LRUs 2.

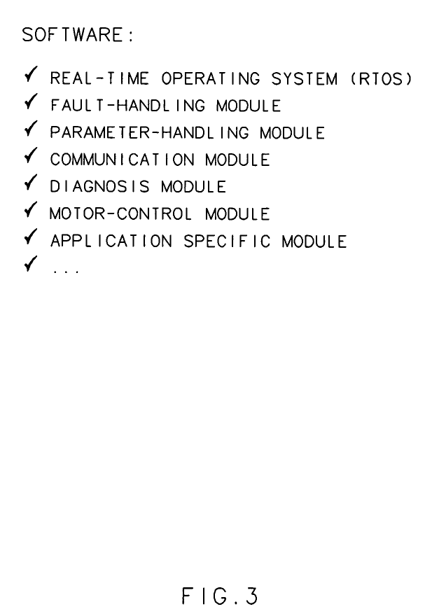

FIG. 3 shows examples of virtual LRU modules that may comprise part of the LRU 2 as well. In FIG. 3, examples of such virtual LRU modules are sub-requirements of software needed for operation of the LRU 2. Typical examples of such virtual LRU modules, as shown, are a real time operating system (RTOS) for the LRU 2, a fault-handling module, a parameter-handling module, a communication module, a diagnosis module, a motor-control module and an application specific module. These examples of virtual LRU modules are based upon functionality, but of course, they could be based upon other LRU sub-requirements, such as upgradeability, for instance.

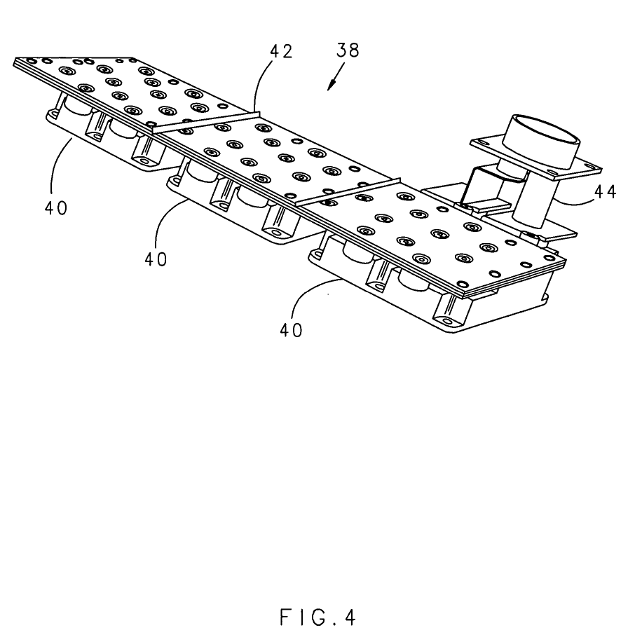

FIG. 4 shows an example of a an embodiment of a LRU module for a typical LRU 2 according to the invention in the form of a power electronics switching block 38. The power-switching block 38 comprises various sub-modules, such as large power-switching transistors 40, a respective gate-drive board sub-module 42 holding the other sub-modules together with a printed-circuit board interconnection scheme, and an electromagnetic interference (EMI) embedded filter with input/output (I/O) interconnects sub-module 44.

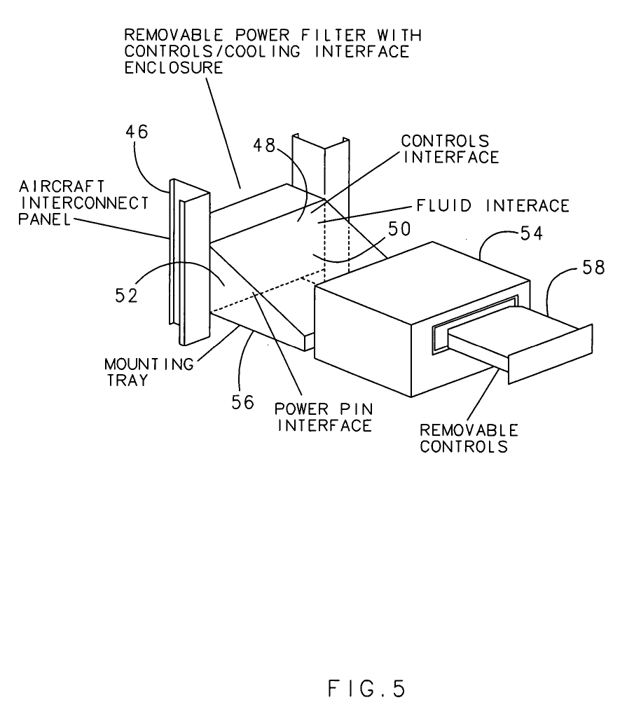

FIG. 5 shows an exploded perspective view of an entire modular LRU 2 according to the invention. In FIG. 5, the LRU 2 comprises a removable power filter with controls. An aircraft interconnect panel 46 connects the LRU 2 to the aerospace electrical power system (not shown). The interconnect panel 46 comprises all signal, power and cooling connections to the aerospace power system that are necessary to support the operation of the LRU 2. The interconnect panel 46 and the LRU 2 have complementary controls interfaces 48, fluid interfaces 50 and power pin interfaces 52 to couple a removable power filter module 54 to the aerospace power system through the interconnect panel 46. A mounting tray 56 may optionally provide additional support for the power filter module 54.

A removable controls sub-module 58 that serves a sub-requirement of the power filter module 54 connects to the module 54 to allow convenient servicing or upgrading of the controls function without removing and replacing the entire LRU 2 or even the power filter module 54. Alternatively, the power filter 54 may be replaced without replacing the controls module 58 by simply connecting the controls module 58 in a replacement power filter module 54.

Modular LRU design according to the invention afford many advantages over prior art LRU design, some of which are as follows:

1. Certification, such as with customers or the Federal Aviation Administration (FAA), at the module level rather than at the LRU level.

2. Manufacturing and operational methods geared around the assembly, test, and repair of efficient modules.

3. Engineering processes and product-development teams geared around modular designs, wherein modular designs are shared within and across various applications and product platforms.

4. Sustaining engineering operations and redesign of modules to accommodate parts obsolescence as well as the incorporation of more powerful feature-rich components.

5. Service, maintenance, repair, and diagnosis at the modular level.

6. Product/Preventive Health Maintenance (PHM) monitoring at the module level within an LRU with diagnostics that may or may not be built in to the units, wherein such PHM tie-ins may be to built-in test requirements; continuous monitoring of critical parameters, characteristics, or any other physical parameter; or continuous monitoring of observer-based models based on controls, modules, LRUs, or any combination thereof.

Described above is an improved LRU of modular design for aerospace applications that has a plurality of removable LRU modules to enhance manufacturability, serviceability, interchangeability and upgradeability of the LRU. It should be understood that these embodiments of the invention are only illustrative implementations of the invention, that the various parts and arrangement thereof may be changed or substituted, and that the invention is only limited by the scope of the attached claims.

What is claimed is:

1. An improved line replaceable unit (LRU) with a modular structure for an application in an aerospace system that has a defined system requirement for the LRU, comprising:
a plurality of LRU modules, with each LRU module serving at least one sub-requirement for the LRU; and
an interface for coupling the LRU modules to each other and to the aerospace system.

2. The modular LRU of claim 1, wherein the system sub-requirements for each LRU module are selected from a group of LRU sub-requirements comprising functionality, form, fit, size, weight, recurring cost, nonrecurring cost, mean-time-between-failures (MTBF), mean-time-to-repair (MTTR).

3. The modular LRU of claim 1, wherein at least one LRU module comprises a LRU virtual module.

4. The modular LRU of claim 3, wherein at least one LRU virtual module comprises software.

5. The modular LRU of claim 1, wherein at least one LRU module comprises at least one sub-module that serves at least one sub-requirement of the LRU module.

6. The modular LRU of claim 5, wherein at least one sub-module comprises a virtual sub-module.

7. The modular LRU of claim 6, wherein at least one LRU virtual module comprises software.

8. The modular LRU of claim 1, wherein the modular LRU has one of a plurality of different designs and at least one LRU module is interchangeable with another one of the different designs.

9. The modular LRU of claim 1, wherein the modular LRU is upgradeable by replacing at least one of the LRU modules with an upgraded LRU module.

10. The modular LRU of claim 9, wherein the replaced and upgraded LRU modules are LRU virtual modules.

11. The modular LRU of claim 1, wherein the aerospace system comprises an electrical power system.

12. The modular LRU of claim 11, wherein the modular LRU comprises a component of the electrical power system.

13. The modular LRU of claim 1, wherein the interface comprises a system interconnect panel.

14. An improved line replaceable unit (LRU) with a modular structure for an application as a component in an aerospace system that has a defined system requirement for the LRU, comprising:
a plurality of LRU modules, with each LRU module serving at least one sub-requirement for the LRU selected from a group of LRU sub-requirements comprising functionality, form, fit, size, weight, recurring cost, nonrecurring cost, mean-time-between-failures (MTBF), mean-time-to-repair (MTTR); and
an interface comprising a system interconnect panel for coupling the LRU modules to each other and to the aerospace system.

15. The modular LRU of claim 14, wherein at least one LRU module comprises a LRU virtual module.

16. The modular LRU of claim 15, wherein at least one LRU virtual module comprises software.

17. The modular LRU of claim 14, wherein at least one LRU module comprises at least one sub-module that serves at least one sub-requirement of the LRU module.

18. The modular LRU of claim 17, wherein at least one sub-module comprises a virtual sub-module.

19. The modular LRU of claim 18, wherein at least one LRU virtual module comprises software.

20. The modular LRU of claim 14, wherein the modular LRU has one of a plurality of different designs and at least one LRU module is interchangeable with another one of the different designs.

21. The modular LRU of claim 14, wherein the modular LRU is upgradeable by replacing at least one of the LRU modules with an upgraded LRU module.

22. The modular LRU of claim 21, wherein the replaced and upgraded LRU modules are LRU virtual modules.

23. The modular LRU of claim 14, wherein the aerospace system comprises an electrical power system.

24. The modular LRU of claim 23, wherein the modular LRU comprises a component of the electrical power system.

25. An improved line replaceable unit (LRU) with a modular structure for an application as a component in an aerospace electrical power system that has a defined system requirement for the LRU, comprising:
a plurality of LRU modules, with each LRU module serving at least one sub-requirement for the LRU selected from a group of LRU sub-requirements comprising functionality, form, fit, size, weight, recurring cost, nonrecurring cost, mean-time-between-failures (MTBF), mean-time-to-repair (MTTR); and
an interface comprising a system interconnect panel for coupling the LRU modules to each other and to the aerospace system.

26. The modular LRU of claim 25, wherein at least one LRU module comprises a LRU virtual module.

27. The modular LRU of claim 26, wherein at least one LRU virtual module comprises software.

28. The modular LRU of claim 25, wherein at least one LRU module comprises at least one sub-module that serves at least one sub-requirement of the LRU module.

29. The modular LRU of claim 28, wherein at least one sub-module comprises a virtual sub-module.

30. The modular LRU of claim 29, wherein at least one LRU virtual module comprises software.

31. The modular LRU of claim 25, wherein the modular LRU has one of a plurality of different designs and at least one LRU module is interchangeable with another one of the different designs.

32. The modular LRU of claim 25, wherein the modular LRU is upgradeable by replacing at least one of the LRU modules with an upgraded LRU module.

33. The modular LRU of claim 32, wherein the replaced and upgraded LRU modules are LRU virtual modules.
